(19) United States
(12) Patent Application Publication
(10) Pub. No.: US 2019/0157899 A1
(43) Pub. Date: May 23, 2019

(54) WIND OR WATER DRIVEN ELECTRIC GENERATOR USED TO RECHARGE Li-ION BATTERIES IN FIELD APPLICATIONS

(71) Applicant: Gissel Barrera Bailey, Ontario, CA (US)

(72) Inventor: Gissel Barrera Bailey, Ontario, CA (US)

(21) Appl. No.: 15/817,284

(22) Filed: Nov. 20, 2017

(51) Int. Cl. H02J 7/32; H02K 7/18; H01M 10/44; H01M 10/46; H01M 10/0525; F03D 9/11; F03D 9/25; F03D 9/32; F03B 13/10

(52) U.S. Cl. CPC H02J 7/32; H02K 7/183; H02K 7/1823; H01M 10/44; H01M 10/465; H01M 2220/30; F03D 9/11; F03D 9/25; F03D 9/32; F03B 13/10; H01M 2220/20; H01M 10/0525

(57) ABSTRACT

This invention relates to the creation of electrical energy ad-hoc, for purposes of charging a battery in a mobile device, where a typical battery charger would not be practical. The system is comprised of a plastic multi-bladed propeller attached to a mechanical shaft on the one end and a series of permanent magnets attached to the shaft on the other end which create an electromagnetic field as they rotate through a series of copper wound coils, wherein said coils are attached to a circuit board further comprising a thermistor and capacitor network attached to a cable which has an interchangeable plug end that can be modified to be attached to a cellular phone, laptop computer, flashlight, game-boy, or any other portable battery powered device, in order to charge the device's internal or external battery part on the go.

This inventions comprised of a rotor, commutator, a shaft, a propeller, and a totally enclosed waterproof housing, attached to a mounting clamp as well as a cable which can be universally adaptable to any mobile device who's battery(ies) requires charging, while away from home, or out in the field, away from other forms of power generation, including solar power.

This device lends itself to being easily fitted to the handlebars of a bicycle, the submerged portion of a row boat, or the exterior of any object that moves through the air or through water that can turn a propellor blade, or turbine fins, or any so configured device, attached to a shaft as described under the teachings herein.

### BACKGROUND OF THE INVENTION

This invention relates generally to a battery charger or a means to recharge a battery in the field where no other means is available including a solar charger.

A battery charger, or recharger, is a device used to put energy into a secondary cell or rechargeable battery by forcing an electrical current through it albeit pulsed or steady and continuous.

The charging protocol (how much voltage or current applied, for how long, and what occurs when charging is complete, for instance) depends on the size and type of the battery being charged. Some battery types have high tolerance for overcharging (continued charging after the battery has been fully charged) and can be recharged by connection to a constant voltage source or a constant current source, depending upon the battery type. Simple chargers of this type must be manually disconnected at the end of the charge cycle, and some battery types absolutely require, (or may use a timer to cut off charging current at some fixed time), that charging stops at approximately as soon as or when charging is complete. Other battery types cannot withstand over-charging, they can therefore become damaged (this can reduce their capacity, or causes reduced lifetime usage) from overheating and even may cause exploding. The charger may have temperature or voltage sensing circuits and a some type of a limiter circuit, or microprocessor controller, to safely adjust the charging current and voltage, determine the state of charge, and cut off at the end of a charge or when certain preset conditions are met.

A trickle charger (slow pulsed charging to keep the battery fully charged when not under any external loading or draw) provides a relatively small amount of current, only enough to counteract self-discharge of a battery that is idle for a long time. Slow battery chargers may take several hours to complete a charge; high-rate chargers may restore most capacity much faster, but high rate chargers can be more than some battery types can tolerate. Such batteries require active monitoring of the battery to protect it from overcharge. Electric vehicles ideally need high-rate chargers; for public access, installation of such chargers and the distribution support for them is an issue in the proposed adoption of electric cars.

A simple charger works by supplying a constant DC or pulsed DC power source to a battery being charged. A simple charger typically does not alter its output based on charging time or the charge on the battery. This simplicity means that a simple charger is inexpensive, but there are trade-offs. Typically, a carefully designed simple charger takes longer to charge a battery than otherwise because it is set to use a lower charging rate to prevent damage. Even so, many batteries left on a simple charger for too long will be weakened or destroyed due to over-charging, These chargers also vary in that they can supply either a constant voltage, or a constant current, to the battery.

Simple AC-powered battery chargers usually have much higher ripple current and ripple voltage than other kinds of battery chargers because they are inexpensively designed and built. Generally, when the ripple current is within a battery's manufacturer recommended level, the ripple voltage will also be well within the recommended level. The maximum ripple current for a typical 12 V 100 Ah VRLA lead acid battery is 5 amps. As long as the ripple current is not excessive (more than 3 to 4 times the battery manufacturer recommended level), the expected life of a ripple-charged VRLA battery will be within 3% of the life of a constant DC-charged battery.

Fast chargers make use of control circuitry to rapidly charge the batteries without damaging any of the cells in the battery. The control circuitry can be built into the battery (generally for each cell) or in the external charging unit, or split between both. Most such chargers have a cooling fan to help keep the temperature of the cells at safe levels. Most are also capable of acting as standard overnight chargers if used with standard NIMH cells that do not have the special control circuitry.

Inductive battery chargers use electromagnetic induction to charge batteries. A charging station sends electromagnetic energy through inductive coupling to an electrical device, which stores the energy in the batteries. This is achieved without the need for metal contacts between the charger and the battery. It is commonly used in electric toothbrushes and other devices used in bathrooms. Because there are no open electrical contacts, there is no risk of electrocution. At present, this charging technique is only applicable to small batteries, not to high capacity systems.

A “smart charger” should not be confused with a “smart battery”. A smart battery is generally defined as one containing some sort of electronic device or “chip” that can communicate with a smart charger about battery characteristics and condition. A smart battery generally requires a smart charger it can communicate with. A smart charger is defined as a charger that can respond to the condition of a battery, and modify its charging actions accordingly.

Some smart chargers are designed to charge:
A. “smart” batteries.
B. “dumb” batteries, which lack any internal electronic circuitry.

The output current of a smart charger depends upon the battery's state. An intelligent charger may monitor the battery's voltage, temperature or time under charge to determine the optimum charge current and to terminate charging.

For Ni—Cd and NIMH batteries, the voltage across the battery increases slowly during the charging process, until the battery is fully charged. After that, the voltage decreases, which indicates to an intelligent charger that the battery is fully charged. Such chargers are often labeled as a ΔV, “delta-V,” or sometimes “delta peak”, charger, indicating that they monitor the voltage change.

The problem is, the magnitude of “delta-V” can become very small or even non-existent if (very) high capacity rechargeable batteries are recharged. This can cause even an intelligent battery charger to not sense that the batteries are actually already fully charged, and continue charging. Over-charging of the batteries will result in some cases. However, many so called intelligent chargers employ a combination of cut off systems, which are intended to prevent overcharging in the vast majority of cases.

A typical intelligent charger fast-charges a battery up to about 85% of its maximum capacity in less than an hour, then switches to trickle charging, which takes several hours to top off the battery to its full capacity.

A Linear induction flashlight, is charged by shaking along its long axis, causing a magnet to slide through a coil of wire to generate electricity.

Several companies have begun making devices that charge batteries based on human motions, as was the teaching in prior art Publication 2006-0139000 filed (2005). One example, made by Tremont Electric, consists of a magnet held between two springs that can charge a battery as the device is moved up and down, such as when walking. Such products have not yet achieved significant commercial success.

Some chargers use pulse technology in which a series of voltage or current pulses are fed to the battery. The DC pulses have a strictly controlled rise time, pulse width, pulse repetition rate (of their frequency) and amplitude. This technology is said to work with any size, voltage, capacity or chemistry of batteries, including automotive and valve-regulated batteries. With pulse charging, high instantaneous voltages can be applied without overheating the battery. In a Lead-acid battery, this breaks down lead-sulfate crystals, thus greatly extending the battery service life.

Several kinds of pulse chargers are patented. Others are open source hardware.

Some chargers use pulses to check the current battery state when the charger is first connected, then use constant current charging during fast charging, then use pulse charging as a kind of trickle charging to maintain the charge.

Some chargers use “negative pulse charging”, also called “reflex charging” or “burp charging”. Such chargers use both positive and brief negative current pulses. There is no significant evidence, however, that negative pulse charging is more effective than ordinary pulse charging.

Solar chargers convert light energy into DC current. They are generally portable, but can also be fixed mounted. Fixed mounted solar chargers are also known as solar panels. Solar panels are often connected to the electrical grid, whereas portable solar chargers are used off-the-grid (i.e. cars, boats, or RVs).

The output of a timer charger is terminated after a pre-determined time. Timer chargers were the most common type for high-capacity Ni—Cd cells in the late 1990s for example. Low-capacity consumer Ni—Cd cells were typically charged with a simple charger).

Often a timer charger and set of batteries could be bought as a bundle and the charger time was set to suit those specific batteries only. If batteries of lower capacity were charged then they would be overcharged, and if batteries of higher capacity were charged they would be only partly charged. With the trend for battery technology to increase capacity year on year, an old time charger would only partly charge the newer batteries.

Timer based chargers also have the drawback that charging batteries that were not fully discharged, even if those batteries were of the correct capacity for the particular timed charger, would result in over-charging.

A trickle charger is typically a low-current (5-1,500 mA) battery charger. A trickle charger is generally used to charge small capacity batteries (2-30 Ah). These types of battery chargers are also used to maintain larger capacity batteries (>30 Ah) that are typically found on cars, boats, RVs and other related vehicles. In larger applications, the current of the battery charger is sufficient only to provide a maintenance or trickle current (trickle is commonly the last charging stage of most battery chargers). Depending on the technology of the trickle charger, it can be left connected to the battery indefinitely.

Some battery chargers that can be left connected to the battery without causing the battery damage are also referred to as smart or intelligent chargers. Note that not all battery types can tolerate trickle charging after being fully charged; most Li-ion batteries are damaged by trickle charging.

The most sophisticated types are used in critical applications (e.g. military or aviation batteries). These heavy-duty automatic “intelligent charging” systems can be programmed with complex charging cycles specified by the battery maker. The best are universal (i.e. can charge all battery types), and include automatic capacity testing and analyzing functions too.

Since the Universal Serial Bus specification provides for a five-volt power supply, it s possible to use a USB cable to connect a device to a power supply. Products based on this approach include chargers for cellular phones, portable digital audio players, and tablet computers. They may be fully compliant USB peripheral devices adhering to USB power discipline, or uncontrolled in the manner of USB decorations.

Although portable solar chargers obtain energy from the sun only, they still can (depending on the technology) be used in low light (i.e. cloudy) applications. Portable solar chargers are typically used for trickle charging, although some solar chargers (depending on the wattage), can completely recharge batteries. Other devices may exist, which combine this with other sources of energy for added recharging efficacy.

Powerbanks are popular for charging smartphones and mobile tablet devices. A powerbank is a portable device that can supply power from its built-in batteries through a USB port. They usually recharge with a USB power supply. Technically, a powerbank consists of rechargeable Lithium-ion or Lithium-Polymer batteries installed in a protective casing, guided by a printed circuit board (PCB) which ensures and provides various protective and safety measures. Due to its general purpose, power banks are also gaining popularity as a branding and promotional tool. Different brands and promotional companies use it as a promotional tool and provide a customized product.

Many powerbanks use the common 18650 size lithium-ion battery which may or may not be user-replaceable.

RN Battery Specifications May Include:
Capacity in Wh: Total power capacity measured by multiplying mAh by voltage.
Capacity in mAh: mAh stands for milli Ampere-hour and measures the amount of power flow that can be supplied by a certain powerbank at a specific voltage. Many manufacturers rate their products at 3.7 v, the voltage of cell(s) inside. Since USB outputs at 5 v calculations at this voltage will yield a lower mAh number. For example, a battery pack advertised with a 3000 mAh capacity (at 3.7 v) will produce 2220 mAh at 5 v. Power losses due to efficiency of the charging circuitry may then also occur.
Simultaneous charging and discharging: need to specify if the powerbank can be used while it is charging.
Number of output USB ports: This specifies the number of devices that can be charged simultaneously.
Output current rating: This specifies the current rating that it can charge maximum. The higher Simultaneous charging and discharging: need to specify if the powerbank can be used while it is charging.
Number of output TSB ports: This specifies the number of devices that can be charged simultaneously.
Output current rating: This specifies the current rating that it can charge maximum). The higher the number, the better the powerbank. This can vary from output port to output port.
Input Current Rating: Input current rating is the amount of current the powerbank is able to draw at its maximum level while getting charged.
Safety Protections: Over Voltage Protection, Over Charge Protections, Over Current Protections, Over Heat Protections, Short-Circuit Protections and Over Discharge Protections are the common safety measures observed with standard powerbanks.
LED Indications: The Led glows as per indicating the amount of charging ability left with the powerbank. Since a battery charger is intended to be connected to a battery, it may not have voltage regulation or filtering of the DC voltage output. Battery chargers equipped with both voltage regulation and filtering are sometimes termed battery eliminators.

There are two main types of charges for vehicles:
A. One used to recharge a fuel vehicle's starter battery, where a modular charger is used; typically an 3-stage charger.
B. To recharge an electric vehicle (EV) battery pack; Chargers for car batteries come in varying ratings.

Chargers that are rated up to two amperes may be used to maintain charge on parked vehicle batteries or for small batteries on garden tractors or similar equipment. A motorist may keep a charger rated a few amperes to ten to fifteen amperes for maintenance of automobile batteries or to recharge a vehicle battery that has accidentally discharged. Service stations and commercial garages will have a large charger to fully charge a battery in an hour or two; often these chargers can briefly source the hundreds of amperes required to crank an internal combustion engine starter.

Electric vehicle battery chargers come in a variety of brands and characteristics. Zivan, Manzanita Micro, Elcon, Quick Charge, Rossco, Brusa, Delta-Q, Kelly, Lester and Soneil are the top 10 EV chargers in 2011 according to EVAlbum.com. These chargers vary from 1 kW to 7.5 kW maximum charge rate. Some use algorithm charge curves, others use constant voltage, constant current. Some are programmable by the end user through a CAN port, some have dials for maximum voltage and amperage, while some are preset to specified battery pack voltage, amp-hour and chemistry. Prices range from $400 to $4500.

A 10 amp-hour battery could take 15 hours to reach a fully charged state from a fully discharged condition with a 1 amp charger, as it would require roughly 1.5 times the battery's capacity.

Public EV charging stations provide 6 kW (host power of 208 to 240 VAC off a 40 amp circuit). 6 kW will recharge an EV roughly 6 times faster than 1 kW overnight charging.

Rapid charging results in even faster recharge times and is limited only by available AC power, battery type, and the type of charging system.

Onboard EV chargers (change AC power to DC power to recharge the EV's pack) can be:
Isolated: they make no physical connection between the AIC electrical mains and the batteries being charged. These typically employ some form of Inductive charging. Some isolated chargers may be used in parallel. This allows for an increased charge current and reduced charging times. The battery has a maximum current rating that cannot be exceeded
Non-isolated: the battery charger has a direct electrical connection to the A/C outlet's wiring.

Power Factor Correction (PFC) chargers can more closely approach the maximum current th plug can deliver, shortening charging time.

Researchers at the Korea Advanced Institute of Science and Technology (KAIST) have developed an electric transport system (called Online Electric Vehicle, OLEV) where the vehicles get their power needs from cables underneath the surface of the road via non-contact magnetic charging, (where a power source is placed underneath the road surface and power is wirelessly picked up on the vehicle itself.

Most mobile phone chargers are not really chargers, only power adapters, that provide a power source for the charging circuitry, which is almost always contained within the mobile phone. Older ones are notoriously diverse, having a wide variety of DC connector-styles and voltages, most of which are not compatible with other manufacturers' phones or even different models of phones from a single manufacturer.

Users of publicly accessible charging kiosks must be able to cross-reference connectors with device brands/models and individual charge parameters and thus ensure delivery of the correct charge for their mobile device. A database-driven system is one solution, and is being incorporated into some designs of charging kiosks.

Mobile phones can usually accept a relatively wide range of voltages, as long as it is sufficiently above the phone battery's voltage. However, if the voltage is too high, it can damage the phone. Mostly, the voltage is 5 volts or slightly higher, but it can sometimes vary up to 12 volts when the power source is not loaded.

There are also human-powered chargers sold on the market, which typically consists of a dynamo powered by a hand crank and extension cords. A French startup offers a kind of dynamo charger inspired by the ratchet that can be used with only one hand. There are also solar chargers, including one that is a fully mobile personal charger and panel, which one can easily transport.

China, the European Commission and other countries are making a national standard on mobile phone chargers using the USB standard. In June 2009, 10 of the world's largest mobile phone manufacturers signed a Memorandum of Understanding to develop specifications for and support a microUSB-equipped common External Power Supply (EPS) for all data-enabled mobile phones sold in the EU. On Oct. 22, 2009, the International Telecommunication Union announced a standard for a universal charger for mobile handsets (Micro-USB).

Telecommunications, electric power, and computer uninterruptible power supply facilities may have very large standby battery banks (installed in battery rooms) to maintain critical loads for several hours during interruptions of primary grid power. Such chargers are permanently installed and equipped with temperature compensation, supervisory alarms for various system faults, and often redundant independent power supplies and redundant rectifier systems. Chargers for stationary battery plants may have adequate voltage regulation and filtration and sufficient current capacity to allow the battery to be disconnected for maintenance, while the charger supplies the DC system load. Capacity of the charger is specified to maintain the system load and recharge a completely discharged battery within 8 hours or other interval.

A battery charger can work as a DC power adapter for experimentation. It may, however, require an external capacitor to be connected across its output terminals in order to “smooth” the voltage sufficiently, which may be thought of as a DC voltage plus a “ripple” voltage added to it. There may be an internal resistance connected to limit the short circuit current, and the value of that internal resistance may have to be taken into consideration in experiments.

What practices are best depend on the type of battery. NiCd cells must be filly discharged occasionally, or else the battery loses capacity over time due to a phenomenon known as “memory effect.” Once a month (once every 30 charges) is sometimes recommended. This extends the life of the battery^{,} since memory effect is prevented while avoiding full charge cycles which are known to be hard on all types of dry-cell batteries, eventually resulting in a permanent decrease in battery capacity.

Most modern cell phones, laptops, and most electric vehicles use Lithium-ion batteries. These batteries last longest if the battery is frequently charged; fully discharging them will degrade their capacity relatively quickly. When storing however, lithium batteries degrade more while fully charged than if they are only 40% charged. As with all battery types, degradation also occurs faster at higher temperatures. Degradation in lithium-ion batteries is caused by an increased internal battery resistance due to cell oxidation. This decreases the efficiency of the battery, resulting in less net current available to be drawn from the battery. However, if Li-ION cells are discharged below a certain voltage a chemical reaction occurs that make them dangerous if recharged, which is why probably all such batteries in consumer goods now have an “electronic fuse” that permanently disables them if the voltage falls below a set level. The electronic fuse draws a small amount of current from the battery, which means that if a laptop battery is left for a long time without charging it, and with a very low initial state of charge, the battery may be permanently destroyed.

Motor vehicles, such as boats, RVs, ATVs, motorcycles, cars, trucks, and more use lead-acid batteries. These batteries employ a sulfuric acid electrolyte and can generally be charged and discharged without exhibiting memory effect, though sulfation (a chemical reaction in the battery which deposits a layer of sulfates on the lead) will occur over time. Typically sulfated batteries are simply replaced with new batteries, and the old ones recycled. Lead-acid batteries will experience substantially longer life when a maintenance charger is used to “float charge” the battery. This prevents the battery from ever being below 100% charge, preventing sulfate from forming. Proper temperature compensated float voltage should be used to achieve the best results.

### SPECIFICATIONS

The key element is the ability to charge batteries by wind power or water movement in remote locations where conventional battery chargers would be inappropriate because there is no wall outlet or generator to plug-into. The system. comprises a plastic multi-bladed propeller or cone shaped wind vane that is propelled by wind or air on the one hand, and or water moving over it or through it on the other hand. A shaft is attached to said propeller on one end and a series of rotating coils are attached to the other end of the shaft, which pass through a magnetic field formed by a series of permanent magnets. As the propellor turns, it thus creates a steady stream of electro magnetic pulses or energy induced into a series of copper wire coils which are connected to a switching network as in a varistor/capacitor network, which feeds an output cable with an mini phono plug or micro USB plug that can be inserted into a mobile device which contains the rechargeable battery that needs to be recharged. It may also comprise a proximity coil, sealed within a plastic container upon which a cellular phone or other hand held or wearable device may rest during the said charging process.

The entire device can be mounted with a spring loaded clamp, onto the handle bars of a bicycle, motorcycle, water boats, jet skis, golf carts, go carts or submersible devices (wherein the propeller is replaced by a venturi type tube, such that the motion of the water through the tube rotates the shaft in a manner similar to the propeller blade).

### DESCRIPTION OF THE DRAWINGS

FIG. 1

Depicts the exploded end to end system components as might be found for example, in the preferred embodiment of the present invention.

FIG. 2

Depicts the venturi tube for underwater use of the invention for example, as might be found in the preferred embodiment of the present invention.

FIG. 3

Depicts the magnetic field created by the permanent magnets as the said coils rotate on the said shaft, creating an electric current flow and thus an energy transfer to the series of copper coils for example, in the preferred embodiment.

FIG. 4

Depict the unit as it might be found on the handle bars of a bicycle for example in the preferred embodiment of the present invention.

FIG. 5

Depicts the unit mounted to the handlebars of a bicycle in the form of a proximity charger wherein there are no wires required to charge a cellular phone for example as might be found in the preferred embodiment of the present invention

### A DETAILED DESCRIPTION OF THE DRAWINGS

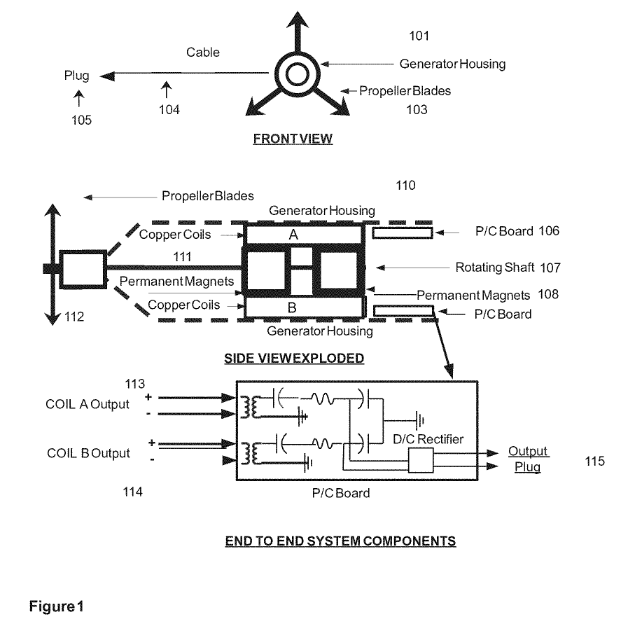

FIG. 1 Depicts the generator inside the housing (101) as might be depicted in the preferred embodiment, further depicting the three propeller blades (102) as might be depicted in the preferred embodiment the said generator attached to USB type plug (105) by cable (104) as might be depicted in the preferred embodiment in the Front View. Further depicting the Internal P/C Board (106) as might be depicted in the preferred embodiment further depicting the Rotating Shaft (107), the Permanent Magnets (108) and the Copper Coils (111)and the Propeller (112) in the side view, and further depicting the exploded view of the internal P/C/Board showing the Coil A Outputs (113) and the Coil B Outputs (114) as well as the internal D/C Rectifier connected to the Output USB type Plug (115) as might be depicted in the preferred embodiment of the present invention for example.

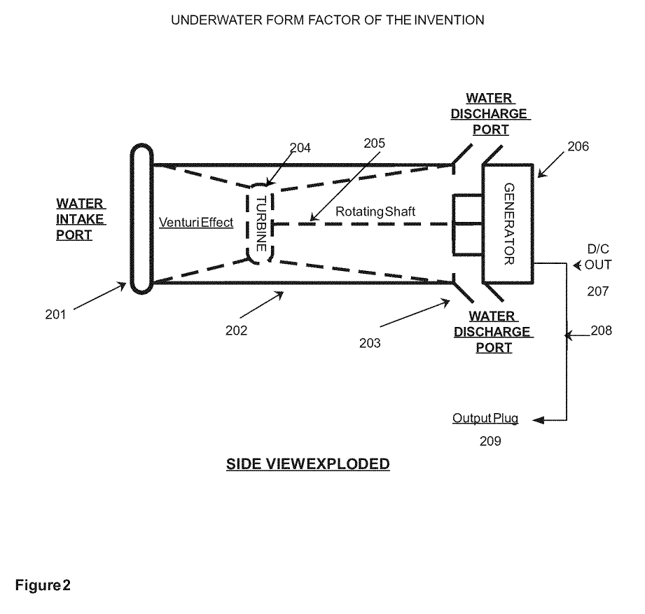

FIG. 2 depicts Water Intake Port (201) the enclosed housing (202) the Water Discharge Port (203) the Turbine Itself (204) the Rotating Shaft (205) The Generator (206) the DIC Output Port (207) connected to the Output Cable (208) connected to the Output Plug (209) as is depicted in the Side View Drawing as might be found in the preferred embodiment of the present invention for example.

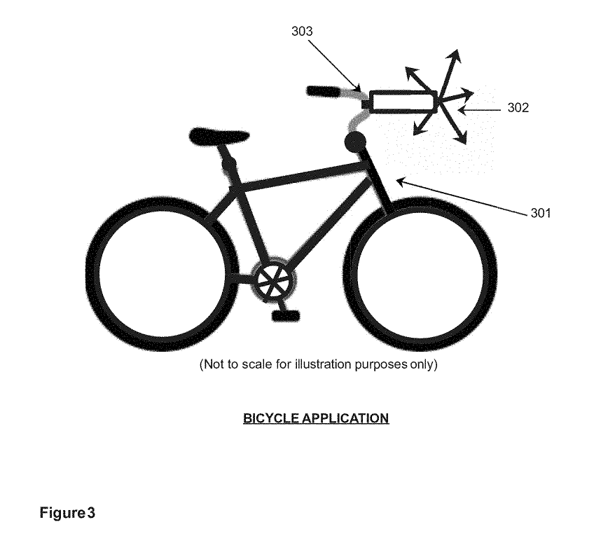

FIG. 3 depicts the Bicycle Application Model showing the Bicycle itself (301) the Generator and Propeller Attached (302) with the Handlebar Clamp (303) as might be found in the preferred embodiment of the present invention for example.

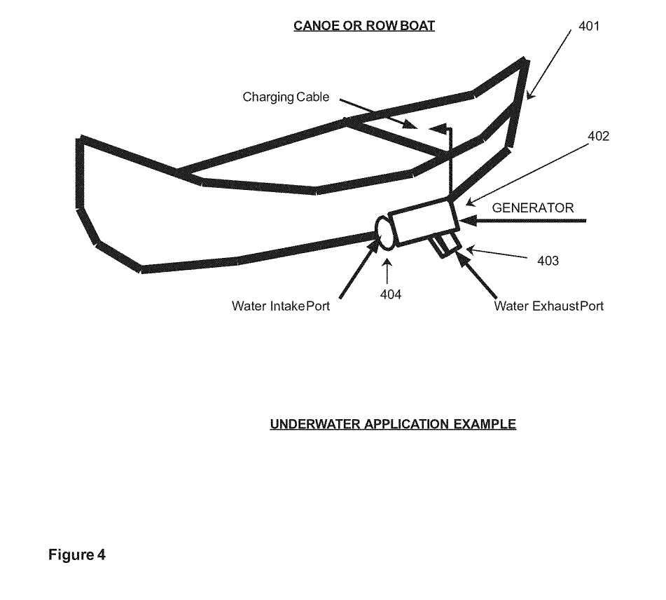

FIG. 4 depicts the Underwater Application Example showing a Canoe (401) the Generator (402) the Water Intake Port (404) and the Water Exhaust Port (403) as might be found in the preferred embodiment of the present invention for example.

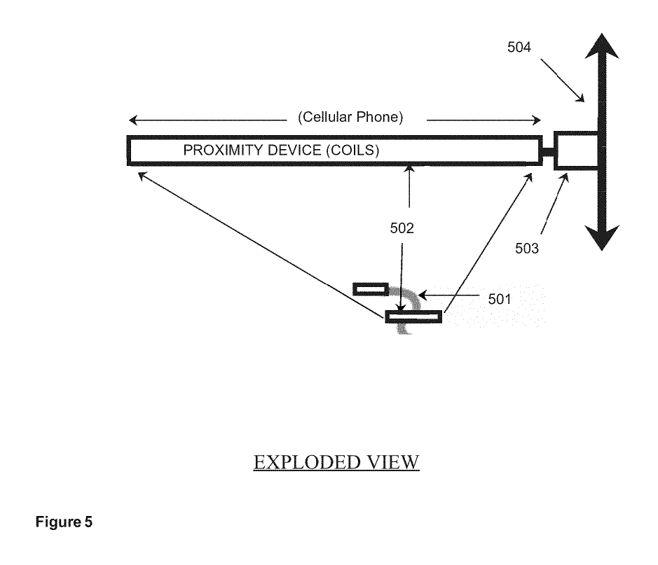

FIG. 5 depicts the Bicycle Handlebars (501) attached to the Proximity Charger (502) further showing the Generator Housing (503) and the Propeller Blade(s) (504) as might be found in the preferred embodiment of the present invention for example.

I claim:

1. A device comprising a plastic, carbon fiber, metal, compressed cardboard, rubber; two bladed, three bladed, or multibladed propellor or venturi type turbine cylinder chamber either or both within a housing that evolve to rotate a rotor connected to a plastic, metal, hardened cardboard, rubber, or carbon fiber shaft, that comprises a set of coils formed from copper or gold wire, that rotate through a magnetic field comprised of an array of magnets attached to a commutator, a capacitor, and a resistor, that generate an electrical impulse as they move that in turn is fed down a wire or wires to a USB, micro USB, or similar defined plug capable of being inserted into a port on a cellular phone, laptop, tablet, wearable device, or other lithium-ion powered hand held or portable device for the express purpose(s) of recharging the said lithium-ion battery where there is no form of electrical power otherwise available at that time.

2. Comprising, all of the components found in claim 1, and further comprising a mounting device to enable easy mounting and removal of the device from the handlebars of a bicycle, unicycle, bicycle built for two, a pedal powered multiseat passenger vehicle for land or sea, where the power to operate the vehicle, is people power.

3. Comprising, all of the components found in claim 1 and claim 2, further comprising a method and means to attach said invention to the bottom of a submersible device such as a boat, a submarine a canoe, a pedal powered water device, a paddle board, a surf board, a raft, a water ski, a jet ski, a snowmobile a kite, a hot air balloon, a glider, a parasail, a hangglider, or other similar outdoor device either people powered, water powered, wind powered, or motion powered, or a combination of all three
